(19) United States
(12) Patent Application Publication
(10) Pub. No.: US 2024/0315351 A1
(43) Pub. Date: Sep. 26, 2024

(54) AEROSOL-GENERATING DEVICE AND SYSTEM COMPRISING AN INDUCTIVE HEATING DEVICE AND METHOD OF OPERATING SAME

(71) Applicant: Philip Morris Products S.A., Neuchatel (CH)

(72) Inventors: Yannick BUTIN, Marin-Epagnier (CH); Maxime CHATEAU, Montlebon (FR)

(73) Assignee: Philip Morris Products S.A., Neuchatel (CH)

(21) Appl. No.: 18/577,916

(22) PCT Filed: Jul. 12, 2022
(86) PCT No.: PCT/EP2022/069456

§ 371 Date: Jan. 9, 2024

(30) Foreign Application Priority Data
Jul. 12, 2021 (EP) 21185109.2

(51) Int. Cl. A24F 40/57; A24F 40/20; A24F 40/465; A24F 40/53

(52) U.S. Cl. CPC A24F 40/57; A24F 40/20; A24F 40/465; A24F 40/53

(57) ABSTRACT

A method for controlling aerosol production in an aerosol-generating device is provided, the device including an inductive heating arrangement and a power source, the method including: performing, during a first heating phase, a first iteration of a calibration process for measuring one or more calibration values associated with a susceptor to heat an aerosol-forming substrate; and during a second heating phase: controlling power provided to adjust a temperature of the susceptor based on a calibration value, re-measuring the value by performing one or more further iterations of the calibration process, the susceptor temperature being adjusted based on the calibration value resulting from a latest iteration of the calibration process prior to adjusting the susceptor temperature, and in response to detecting a puff, preventing re-measuring of the calibration value.

The present disclosure relates to an inductive heating device for heating an aerosol-forming substrate. The present invention further relates to an aerosol-generating device comprising such an inductive heating device and a method for controlling aerosol production in the aerosol-generating device.

Aerosol-generating devices may comprise an electrically-operated heat source that is configured to heat an aerosol-forming substrate to produce an aerosol. It is important for aerosol-generating devices to accurately monitor and control the temperature of the electrically operated heat source to ensure optimum generation and delivery of an aerosol to a user. In particular, it is important to ensure that the electrically-operated heat source does not overheat the aerosol-forming substrate as this may lead to generation of undesirable compounds as well as an unpleasant taste and aroma for the user. To this end, aerosol-generating devices may comprise safety mechanisms in response to detection of overheating, such as generating an alarm and switching off the electrically-operated heat source.

It would be desirable to provide temperature monitoring and control of an inductive heating device that provides for reliable temperature regulation in order to reduce the risk of overheating and ensure continued normal operation of the aerosol-generating device.

According to an embodiment of the present invention, there is provided a method for controlling aerosol production in an aerosol-generating device. The device comprises an inductive heating arrangement and a power source for providing power to the inductive heating arrangement. The method comprises: performing, during a first heating phase during user operation of the aerosol-generating device for producing an aerosol, a first iteration of a calibration process for measuring one or more calibration values associated with a susceptor inductively coupled to the inductive heating arrangement, wherein the susceptor is configured to heat an aerosol-forming substrate; and during a second heating phase during user operation of the aerosol-generating device for producing an aerosol: controlling power provided to the inductive heating arrangement such that the temperature of the susceptor is adjusted based on the one or more calibration values; and re-measuring at least one of the one or more calibration values by performing one or more further iterations of the calibration process for adjusting the one or more calibration values. The temperature of the susceptor is adjusted based at least in part on the at least one of the one or more calibration values resulting from a latest iteration of the calibration process prior to adjusting the temperature of the susceptor.

Because the temperature of the susceptor is adjusted based on one or more measured calibration values, re-measuring at least one of the one or more calibration values and adjusting the temperature of the susceptor based on a latest one of the re-measured at least one of the one or more calibration values enables the temperature of the susceptor to be more accurately and reliably regulated. This prevents overheating for improved safety of the device when the aerosol-generating device is operating at or close to a maximum temperature. Further, overheating of the aerosol-forming substrate may result in the formation of undesired components of the aerosol-forming substrate. Thus, the more accurate and reliable regulation of the temperature of the susceptor improves safety for the user.

The one or more further iterations of the calibration process may be performed at predetermined time intervals. Each of the predetermined time intervals may be between 20 seconds and 50 seconds.

The one or more further iterations of the calibration process may be performed in response to detecting an end of a puff.

This further improves the accuracy and reliability of the temperature regulation because the calibration values are measured regularly as well as, additionally or alternatively, in response to any changes in the aerosol-generating device.

In response to detecting a puff during user operation of the device, re-measuring the at least one of the one or more calibration values may be prevented. Preventing re-measuring the at least one of the one or more calibration values in response to detecting a puff may comprise, in response to detecting the puff at a predetermined duration of time before performing a respective iteration of calibration process, postponing the respective iteration of the calibration process for the duration of the detected puff. The predetermined duration of time before the respective iteration of the calibration process may be between 2 seconds and 5 seconds. Preventing re-measuring the at least one of the one or more calibration values in response to detecting a puff may further comprise, in response to detecting the puff during a respective iteration of the calibration process, stopping the respective iteration of the calibration process.

This provides the advantage of obtaining more reliable calibration values, thereby improving temperature regulation and preventing overheating of the susceptor. In addition to preventing the puff from affecting the re-measuring of the calibration values, this also prevents the performing further iterations of at least part of the calibration process from interfering with aerosol-production and having an effect of the user experience of inhaling the aerosol.

The method may further comprise, in response to detecting that the puff is completed, performing the respective iteration of the calibration process.

The aerosol-generating device may further comprise a cavity configured to receive the aerosol-generating substrate, and wherein the method further comprises detecting the puff by detecting a change of temperature of air flow in the cavity. One of a thermocouple, a negative temperature coefficient resistive temperature sensor and a positive temperature coefficient resistive temperature sensor may be used to detect the change of temperature of air flow in the cavity. The aerosol-generating device may further comprise a cavity configured to receive the aerosol-generating substrate. The method may further comprise detecting the puff by detecting a change of pressure of air flow in the cavity. The method may further comprise detecting the puff by detecting a change of current, resistance or conductance associated with the susceptor.

Performing the calibration process may comprise: controlling the power provided to the inductive heating arrangement to cause heating and cooling of the susceptor through a predetermined temperature range; and monitoring a power source parameter to identify a start point and an end point of a reversible phase transition of the susceptor. The one or more calibration values may comprise at least a first power source parameter value corresponding to the start point of the reversible phase transition of the susceptor and a second power source parameter value corresponding to the end point of the reversible phase transition of the susceptor.

Identifying the start point of the reversible phase transition of the susceptor may comprise measuring a first sequence of power source parameter values with decreasing temperature of the susceptor.

Identifying the end point of the reversible phase transition of the susceptor may comprise measuring a second sequence of power source parameter values with increasing temperature of the susceptor.

Re-measuring at least one of the one or more calibration values by performing one or more further iterations of the calibration process for adjusting the one or more calibration values may comprise re-measuring at least the second power source parameter value.

By measuring at least the second power source parameter value, the length of each of the further iterations of at least a portion of the calibration process may be shortened compared to the first iteration of the calibration process. This ensures that the further iterations of the calibration process do not affect aerosol production during the second heating phase.

Performing one or more further iterations of the calibration process may comprise: controlling the power provided to the inductive heating arrangement to cause an increase of the temperature of the susceptor; monitoring the power source parameter to identify the end point of the reversible phase transition of the susceptor; and interrupting provision of power to the inductive heating arrangement when the end point is detected, wherein the power source parameter value at the end point is the second power source parameter value.

Monitoring the power source parameter to identify the end point of the reversible phase transition of the susceptor may comprise measuring a sequence of power source parameter values with increasing temperature of the susceptor.

Controlling the power provided to the inductive heating arrangement may comprise adjusting, according to a heating profile, the power source parameter with reference to at least one of the first power source parameter value and the second power source parameter value.

Controlling the power provided to the inductive heating arrangement may comprise maintaining the power supply parameter between the first power supply parameter value and the second power supply parameter value.

A temperature of the susceptor associated with the second power source parameter value may correspond to a Curie temperature of a material of the susceptor. A temperature of the susceptor associated with the first power source parameter value may correspond to a temperature at maximum permeability of the material of the susceptor.

The susceptor may comprise a first susceptor material having a first Curie temperature and a second susceptor material having a second Curie temperature. The second Curie temperature may be lower than the first Curie temperature. A temperature of the susceptor associated with the second power source parameter value may correspond to the second Curie temperature of the second susceptor material.

By adjusting the temperature of the susceptor based on the second power source value that corresponds to the second Curie temperature of the second susceptor material, where the second Curie temperature is lower than the first Curie temperature of the second susceptor material, overheating may be prevented.

The power source parameter may be one of a current, a conductance or a resistance.

According to an embodiment of the present invention, there is provided an aerosol-generating device comprising: a power source for providing a DC supply voltage and a DC current; and power supply electronics connected to the power source. The power supply electronics comprise: a DC/AC converter; an inductor connected to the DC/AC converter for the generation of an alternating magnetic field, when energized by an alternating current from the DC/AC converter, the inductor being couplable to a susceptor, wherein the susceptor is configured to heat an aerosol-forming substrate; and a controller. The controller is configured to: perform, during a first heating phase during user operation of the aerosol-generating device for producing an aerosol, a first iteration of a calibration process for measuring one or more calibration values associated with the susceptor; and during a second heating phase during user operation of the aerosol-generating device for producing an aerosol: control power provided to the power supply electronics such that the temperature of the susceptor is adjusted based on the one or more calibration values; and re-measure at least one of the one or more calibration values by performing one or more further iterations of the calibration process for adjusting the one or more calibration values. The temperature of the susceptor is adjusted based at least in part on the at least one of the one or more calibration values resulting from a latest iteration of the calibration process prior to adjusting the temperature of the susceptor.

The one or more further iterations of the calibration process may be performed at predetermined time intervals. Each of the predetermined time intervals may be between 20 seconds and 50 seconds.

The one or more further iterations of the calibration process may be performed in response to detecting an end of a puff.

The controller may be further configured to, in response to detecting a puff during user operation of the device, prevent re-measuring the at least one of the one or more calibration values. Preventing re-measuring the at least one of the one or more calibration values in response to detecting a puff may comprise, in response to detecting the puff at a predetermined duration of time before performing a respective iteration of calibration process, postponing performing a respective iteration of the calibration process for the duration of the detected puff. The predetermined duration of time before the respective iteration of the calibration process may be between 2 seconds and 5 seconds. Preventing re-measuring the at least one of the one or more calibration values in response to detecting a puff may comprise, in response to detecting the puff during a respective iteration of the calibration process, stop the respective iteration of the calibration process.

The controller may be further configured to, in response to detecting that the puff is completed, perform the respective iteration of the calibration process.

The aerosol-generating device may further comprise: a cavity configured to receive the aerosol-generating substrate; and a temperature sensor located within the cavity for measuring a temperature of air flow in the cavity. The controller may be configured to detect the puff based on a change of the temperature of the air flow in the cavity. The temperature sensor may comprise one or more of a thermocouple, a negative temperature coefficient resistive temperature sensor and a positive temperature coefficient resistive temperature sensor.

The aerosol-generating device may further comprise: a cavity configured to receive the aerosol-generating substrate; and a pressure sensor located within the cavity for measuring a pressure of air flow in the cavity. The controller may be configured to detect the puff based on a change of the pressure of the air flow in the cavity.

The controller may be configured to detect the puff based on a change of current, resistance or conductance associated with the susceptor.

Performing the calibration process may comprise: controlling the power provided to the inductive heating arrangement to cause heating and cooling of the susceptor through a predetermined temperature range; and monitoring a power source parameter to identify a start point and an end point of a reversible phase transition of the susceptor. The one or more calibration values may comprise at least a first power source parameter value corresponding to the start point of the reversible phase transition of the susceptor and a second power source parameter value corresponding to the end point of the reversible phase transition of the susceptor.

Identifying the start point of the reversible phase transition of the susceptor may comprise: measuring a first sequence of power source parameter values with decreasing temperature of the susceptor.

Identifying the end point of the reversible phase transition of the susceptor may comprise: measuring a second sequence of power source parameter values with increasing temperature of the susceptor.

Re-measuring at least one of the one or more calibration values by performing one or more further iterations of the calibration process for adjusting the one or more calibration values may comprise re-measuring at least the second power source parameter value.

Performing one or more further iterations of the calibration process may comprise: controlling the power provided to the inductive heating arrangement to cause an increase of the temperature of the susceptor; monitoring the power source parameter to identify the end point of the reversible phase transition of the susceptor; and interrupting provision of power to the inductive heating arrangement when the end point is detected, wherein the power source parameter value at the end point is the second power source parameter value.

Monitoring the power source parameter to identify the end point of the reversible phase transition of the susceptor may comprise: measuring a sequence of power source parameter values with increasing temperature of the susceptor.

Controlling the power provided to the inductive heating arrangement may comprise adjusting, according to a heating profile, the power source parameter with reference to at least one of the first power source parameter value and the second power source parameter value.

Controlling the power provided to the inductive heating arrangement may comprise maintaining the power supply parameter between the first power supply parameter value and the second power supply parameter value.

A temperature of the susceptor associated with the second power source parameter value may correspond to a Curie temperature of a material of the susceptor. A temperature of the susceptor associated with the first power source parameter value may correspond to a temperature at maximum permeability of the material of the susceptor.

The susceptor may comprise a first susceptor material having a first Curie temperature and a second susceptor material having a second Curie temperature. The second Curie temperature is lower than the first Curie temperature. A temperature of the susceptor associated with the second power source parameter value may correspond to the second Curie temperature of the second susceptor material.

According to an embodiment of the present invention, there is provided an aerosol-generating system, comprising: the aerosol-generating device described above; and an aerosol-generating article, wherein the aerosol-generating article comprises the aerosol-forming substrate and the susceptor in thermal contact with the aerosol-forming substrate.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, “aerosol-cooling element” refers to a component of an aerosol-generating article located downstream of the aerosol-forming substrate such that, in use, an aerosol formed by volatile compounds released from the aerosol-forming substrate passes through and is cooled by the aerosol cooling element before being inhaled by a user. An aerosol cooling element has a large surface area, but causes a low pressure drop. Filters and other mouthpieces that produce a high pressure drop, for example filters formed from bundles of fibers, are not considered to be aerosol-cooling elements. Chambers and cavities within an aerosol-generating article are not considered to be aerosol cooling elements.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

As used herein, the term “temperature detector” refers to a thermocouple, a negative temperature coefficient resistive temperature sensor or a positive temperature coefficient resistive temperature sensor.

The invention is defined in the claims. However, below there is provided a non-exhaustive list of non-limiting examples. Any one or more of the features of these examples may be combined with any one or more features of another example, embodiment, or aspect described herein.

Example Ex1: A method for controlling aerosol production in an aerosol-generating device, the device comprising an inductive heating arrangement and a power source for providing power to the inductive heating arrangement, and the method comprising: performing, during a first heating phase during user operation of the aerosol-generating device for producing an aerosol, a first iteration of a calibration process for measuring one or more calibration values associated with a susceptor inductively coupled to the inductive heating arrangement, wherein the susceptor is configured to heat an aerosol-forming substrate; and during a second heating phase during user operation of the aerosol-generating device for producing an aerosol: controlling power provided to the inductive heating arrangement such that the temperature of the susceptor is adjusted based on the one or more calibration values; and re-measuring at least one of the one or more calibration values by performing one or more further iterations of the calibration process for adjusting the one or more calibration values, wherein the temperature of the susceptor is adjusted based at least in part on the at least one of the one or more calibration values resulting from a latest iteration of the calibration process prior to adjusting the temperature of the susceptor.

Example Ex2: The method according to example Ex1, wherein the one or more further iterations of the calibration process are performed at predetermined time intervals.

Example Ex3: The method according to example Ex2, wherein each of the predetermined time intervals is between 20 seconds and 50 seconds.

Example Ex4: The method according to example Ex1, wherein the one or more further iterations of the calibration process are performed in response to detecting an end of a puff.

Example Ex5: The method according to any of examples Ex1 to Ex4, further comprising, in response to detecting a puff during user operation of the device, preventing re-measuring the at least one of the one or more calibration values.

Example Ex6: The method according to example Ex5, wherein preventing re-measuring the at least one of the one or more calibration values in response to detecting a puff comprises, in response to detecting the puff at a predetermined duration of time before performing a respective iteration of calibration process, postponing the respective iteration of the calibration process for the duration of the detected puff.

Example Ex7: The method according to example Ex6, wherein the predetermined duration of time before the respective iteration of the calibration process is between 2 seconds and 5 seconds.

Example Ex8: The method according to any of examples Ex5 to Ex7, wherein preventing re-measuring the at least one of the one or more calibration values in response to detecting a puff comprises, in response to detecting the puff during a respective iteration of the calibration process, stopping the respective iteration of the calibration process.

Example Ex9: The method according to any of examples Ex5 to Ex8 further comprising, in response to detecting that the puff is completed, performing the respective iteration of the calibration process.

Example Ex10: The method according to any of examples Ex4 to Ex9, wherein the aerosol-generating device further comprises a cavity configured to receive the aerosol-generating substrate, and wherein the method further comprises detecting the puff by detecting a change of temperature of air flow in the cavity.

Example Ex11: The method of example Ex10, further comprising detecting the change of temperature of air flow in the cavity using one of a thermocouple, a negative temperature coefficient resistive temperature sensor and a positive temperature coefficient resistive temperature sensor.

Example Ex12: The method according to any of examples Ex4 to Ex9, wherein the aerosol-generating device further comprises a cavity configured to receive the aerosol-generating substrate, the method further comprising detecting the puff by detecting a change of pressure of air flow in the cavity.

Example Ex13: The method according to any of examples Ex4 to Ex9, further comprising detecting the puff by detecting a change of current, resistance or conductance associated with the susceptor.

Example Ex14: The method according to any of examples Ex1 to Ex13, wherein performing the calibration process comprises: controlling the power provided to the inductive heating arrangement to cause heating and cooling of the susceptor through a predetermined temperature range; and monitoring a power source parameter to identify a start point and an end point of a reversible phase transition of the susceptor, wherein the one or more calibration values comprise at least a first power source parameter value corresponding to the start point of the reversible phase transition of the susceptor and a second power source parameter value corresponding to the end point of the reversible phase transition of the susceptor.

Example Ex15: The method according to example Ex14, wherein identifying the start point of the reversible phase transition of the susceptor comprises measuring a first sequence of power source parameter values with decreasing temperature of the susceptor, and wherein identifying the end point of the reversible phase transition of the susceptor comprises measuring a second sequence of power source parameter values with increasing temperature of the susceptor.

Example Ex16: The method according to example Ex14 or Ex15, wherein re-measuring at least one of the one or more calibration values by performing one or more further iterations of the calibration process for adjusting the one or more calibration values comprises re-measuring at least the second power source parameter value.

Example Ex17: The method according to any of examples Ex14 to Ex16, wherein performing one or more further iterations of the calibration process comprises: controlling the power provided to the inductive heating arrangement to cause an increase of the temperature of the susceptor; monitoring the power source parameter to identify the end point of the reversible phase transition of the susceptor; and interrupting provision of power to the inductive heating arrangement when the end point is detected, wherein the power source parameter value at the end point is the second power source parameter value.

Example Ex18: The method according to example Ex17, wherein monitoring the power source parameter to identify the end point of the reversible phase transition of the susceptor comprises measuring a sequence of power source parameter values with increasing temperature of the susceptor.

Example Ex19: The method according to one of examples Ex14 to Ex18, wherein controlling the power provided to the inductive heating arrangement comprises adjusting, according to a heating profile, the power source parameter with reference to at least one of the first power source parameter value and the second power source parameter value.

Example Ex20: The method according to any of examples Ex14 to Ex19, wherein controlling the power provided to the inductive heating arrangement comprises maintaining the power supply parameter between the first power supply parameter value and the second power supply parameter value.

Example Ex21: The method according to any of examples Ex14 to Ex20, wherein a temperature of the susceptor associated with the second power source parameter value corresponds to a Curie temperature of a material of the susceptor.

Example Ex22: The method according to example Ex21, wherein a temperature of the susceptor associated with the first power source parameter value corresponds to a temperature at maximum permeability of the material of the susceptor.

Example Ex23: The method according to any of examples Ex14 to Ex20, wherein the susceptor comprises a first susceptor material having a first Curie temperature and a second susceptor material having a second Curie temperature, wherein the second Curie temperature is lower than the first Curie temperature, and wherein a temperature of the susceptor associated with the second power source parameter value corresponds to the second Curie temperature of the second susceptor material.

Example Ex24: The method according to any of examples Ex14 to Ex23, wherein the power source parameter is one of a current, a conductance or a resistance.

Example Ex25: An aerosol-generating device comprising: a power source for providing a DC supply voltage and a DC current; power supply electronics connected to the power source, the power supply electronics comprising: a DC/AC converter; an inductor connected to the DC/AC converter for the generation of an alternating magnetic field, when energized by an alternating current from the DC/AC converter, the inductor being couplable to a susceptor, wherein the susceptor is configured to heat an aerosol-forming substrate; and a controller configured to: perform, during a first heating phase during user operation of the aerosol-generating device for producing an aerosol, a first iteration of a calibration process for measuring one or more calibration values associated with the susceptor; and during a second heating phase during user operation of the aerosol-generating device for producing an aerosol: control power provided to the power supply electronics such that the temperature of the susceptor is adjusted based on the one or more calibration values; and re-measure at least one of the one or more calibration values by performing one or more further iterations of the calibration process for adjusting the one or more calibration values, wherein the temperature of the susceptor is adjusted based at least in part on the at least one of the one or more calibration values resulting from a latest iteration of the calibration process prior to adjusting the temperature of the susceptor.

Example Ex26: The aerosol-generating device according to example Ex25, wherein the one or more further iterations of the calibration process are performed at predetermined time intervals.

Example Ex27: The aerosol-generating device according to example Ex26, wherein each of the predetermined time intervals is between 20 seconds and 50 seconds.

Example Ex28: The aerosol-generating device according to example Ex25, wherein the one or more further iterations of the calibration process are performed in response to detecting an end of a puff.

Example Ex29: The aerosol-generating device according to any of examples Ex25 to Ex28, wherein the controller is further configured to, in response to detecting a puff during user operation of the device, prevent re-measuring the at least one of the one or more calibration values. Example Ex30: The aerosol-generating device according to example Ex29, wherein preventing re-measuring the at least one of the one or more calibration values in response to detecting a puff comprises, in response to detecting a puff at a predetermined duration of time before performing a respective iteration of calibration process, postpone performing a respective iteration of the calibration process for the duration of the detected puff.

Example Ex31: The aerosol-generating device according to example Ex30, wherein the predetermined duration of time before the respective iteration of the calibration process is between 2 seconds and 5 seconds.

Example Ex32. The aerosol-generating device according to any of examples Ex29 to Ex31, preventing re-measuring the at least one of the one or more calibration values in response to detecting a puff comprises, in response to detecting a puff during a respective iteration of the calibration process, stop the respective iteration of the calibration process.

Example Ex33: The aerosol-generating device according to any of examples Ex29 to Ex32, wherein the controller is further configured to, in response to detecting that the puff is completed, perform the respective iteration of the calibration process.

Example Ex34: The aerosol-generating device according to any of examples Ex28 to Ex33, wherein the aerosol-generating device further comprises: a cavity configured to receive the aerosol-generating substrate; and a temperature sensor located within the cavity for measuring a temperature of air flow in the cavity, wherein the controller is configured to detect the puff based on a change of the temperature of the air flow in the cavity.

Example Ex35: The aerosol-generating device of example Ex34, wherein the temperature sensor comprises one or more of a thermocouple, a negative temperature coefficient resistive temperature sensor and a positive temperature coefficient resistive temperature sensor.

Example Ex36: The aerosol-generating device according to any of examples Ex28 to Ex33, wherein the aerosol-generating device further comprises: a cavity configured to receive the aerosol-generating substrate; and a pressure sensor located within the cavity for measuring a pressure of air flow in the cavity, wherein the controller is configured to detect the puff based on a change of the pressure of the air flow in the cavity.

Example Ex37: The aerosol-generating device according to any of examples Ex28 to Ex33, wherein the controller is configured to detect the puff based on a change of current, resistance or conductance associated with the susceptor.

Example Ex38: The aerosol-generating device according to any of examples Ex25 to Ex37, wherein performing the calibration process comprises: controlling the power provided to the inductive heating arrangement to cause heating and cooling of the susceptor through a predetermined temperature range; and monitoring a power source parameter to identify a start point and an end point of a reversible phase transition of the susceptor, wherein the one or more calibration values comprise at least a first power source parameter value corresponding to the start point of the reversible phase transition of the susceptor and a second power source parameter value corresponding to the end point of the reversible phase transition of the susceptor.

Example Ex39: The aerosol-generating device according to example Ex38, wherein identifying the start point of the reversible phase transition of the susceptor comprises measuring a first sequence of power source parameter values with decreasing temperature of the susceptor, and wherein identifying the end point of the reversible phase transition of the susceptor comprises measuring a second sequence of power source parameter values with increasing temperature of the susceptor.

Example Ex40: The aerosol-generating device according to example Ex38 or Ex39, wherein re-measuring at least one of the one or more calibration values by performing one or more further iterations of the calibration process for adjusting the one or more calibration values comprises re-measuring at least the second power source parameter value.

Example Ex41: The aerosol-generating device according to any of examples Ex38 to Ex40, wherein performing one or more further iterations of the calibration process comprises: controlling the power provided to the inductive heating arrangement to cause an increase of the temperature of the susceptor; monitoring the power source parameter to identify the end point of the reversible phase transition of the susceptor; and interrupting provision of power to the inductive heating arrangement when the end point is detected, wherein the power source parameter value at the end point is the second power source parameter value.

Example Ex42: The aerosol-generating device according to example Ex41, wherein monitoring the power source parameter to identify the end point of the reversible phase transition of the susceptor comprises measuring a sequence of power source parameter values with increasing temperature of the susceptor.

Example Ex43: The aerosol-generating device according to one of examples Ex38 to Ex42, wherein controlling the power provided to the inductive heating arrangement comprises adjusting, according to a heating profile, the power source parameter with reference to at least one of the first power source parameter value and the second power source parameter value.

Example Ex44: The aerosol-generating device according to any of examples Ex38 to Ex43, wherein controlling the power provided to the inductive heating arrangement comprises maintaining the power supply parameter between the first power supply parameter value and the second power supply parameter value.

Example Ex45: The aerosol-generating device according to any of examples Ex38 to Ex44, wherein the temperature of the susceptor associated with the second power source parameter value corresponds to a Curie temperature of a material of the susceptor.

Example Ex46: The aerosol-generating device according to example Ex45, wherein the temperature of the susceptor associated with the first power source parameter value corresponds to a temperature at maximum permeability of the material of the susceptor.

Example Ex47: The aerosol-generating device according to any of examples Ex38 to Ex44, wherein the susceptor comprises a first susceptor material having a first Curie temperature and a second susceptor material having a second Curie temperature, wherein the second Curie temperature is lower than the first Curie temperature, and wherein a calibration temperature associated with the second power source parameter value corresponds to the second Curie temperature of the second susceptor material.

Example Ex48: The aerosol-generating device according to any of examples Ex38 to Ex47, wherein the power source parameter is one of a current, a conductance or a resistance.

Example Ex49: An aerosol-generating system, comprising: the aerosol-generating device according to one of claims 25 to 48; and an aerosol-generating article, wherein the aerosol-generating article comprises the aerosol-forming substrate and the susceptor in thermal contact with the aerosol-forming substrate.

Examples will now be further described with reference to the figures in which:

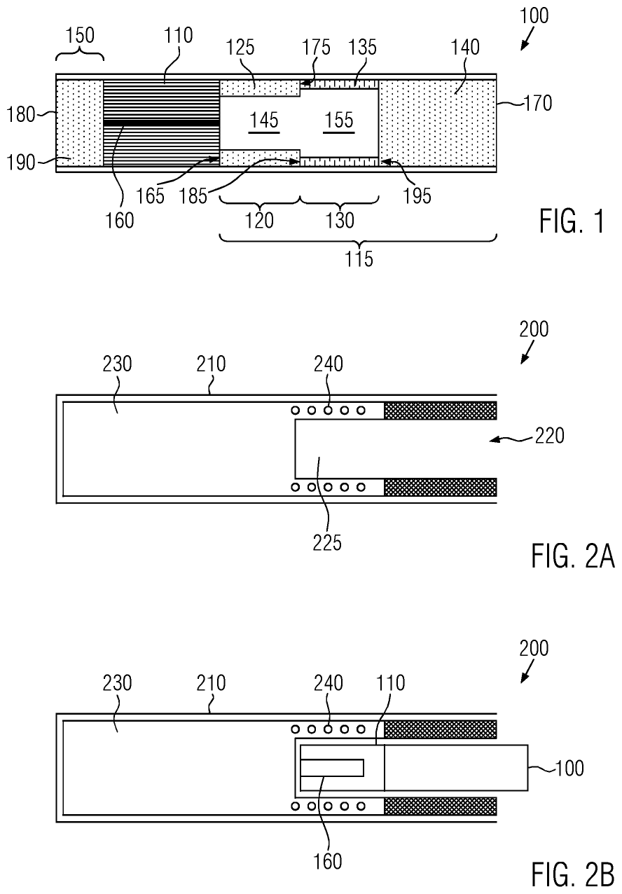

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

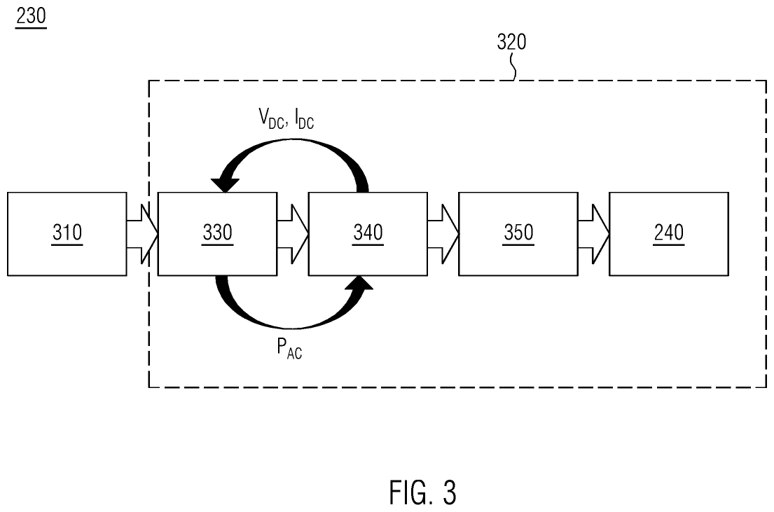

FIG. 3 is a block diagram showing an inductive heating device of the aerosol-generating device described in relation to FIG. 2;

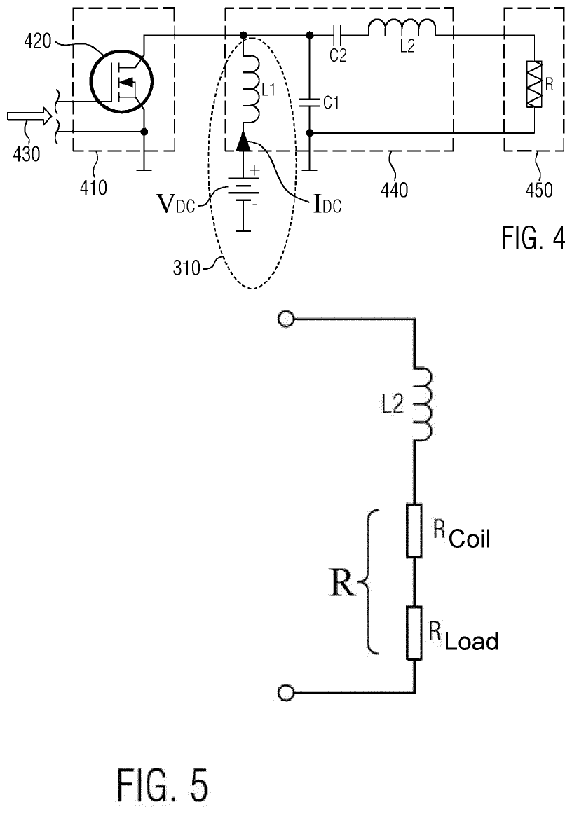

FIG. 4 is a schematic diagram showing electronic components of the inductive heating device described in relation to FIG. 3;

FIG. 5 is a schematic diagram on an inductor of an LC load network of the inductive heating device described in relation to FIG. 4;

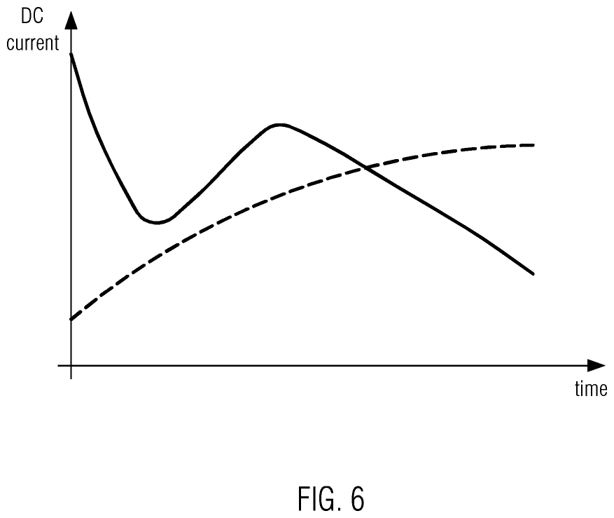

FIG. 6 is a graph of DC current vs. time illustrating the remotely detectable current changes that occur when a susceptor material undergoes a phase transition associated with its Curie point;

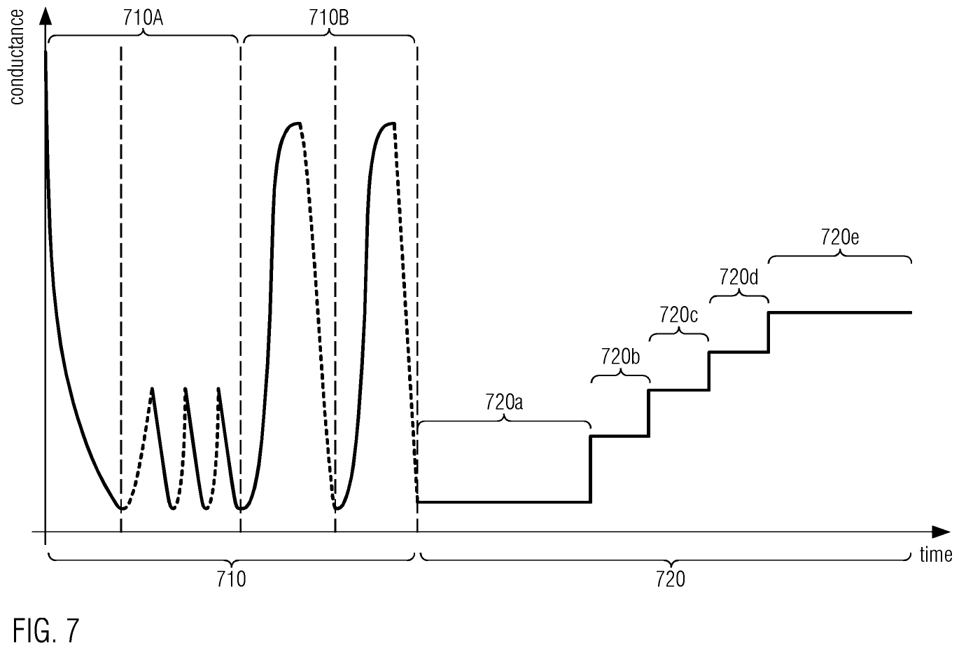

FIG. 7 illustrates a temperature profile of the susceptor during operation of the aerosol-generating device;

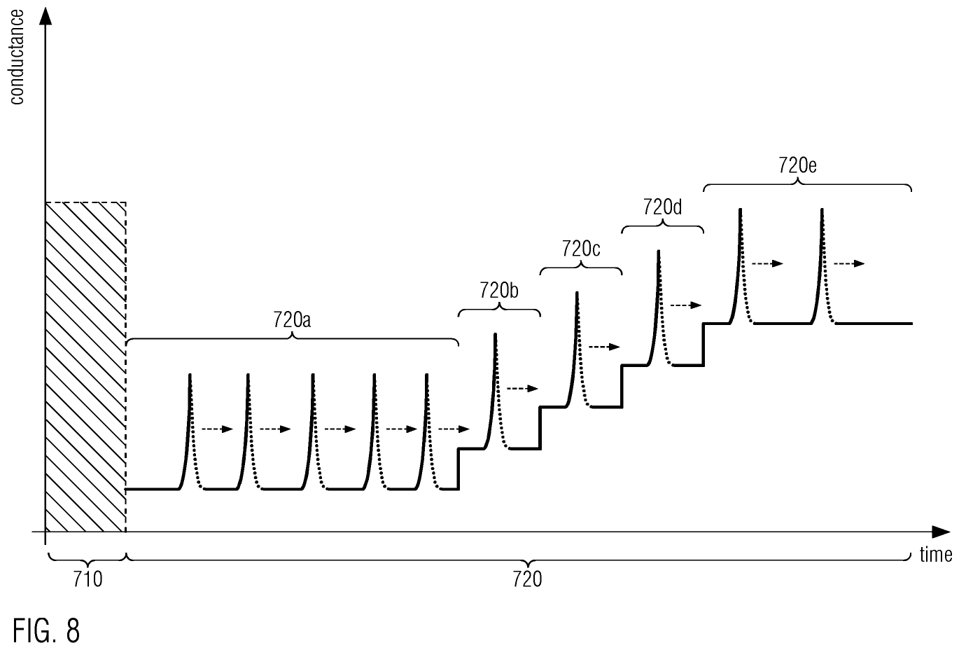

FIG. 8 illustrates the temperature profile of the susceptor during operation of the aerosol-generating device and shows the second heating phase in more detail; and

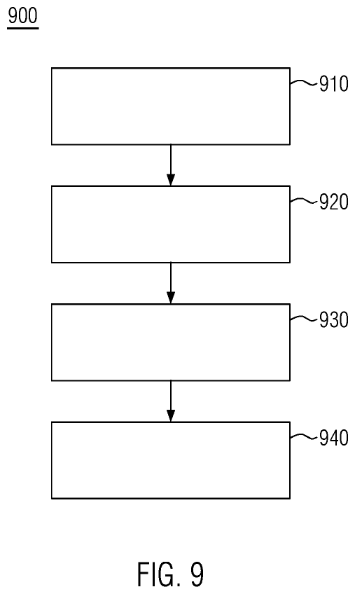

FIG. 9 is a flow diagram showing a method for controlling aerosol-production in the aerosol-generating device of FIG. 2.

FIG. 1 illustrates a schematic side sectional view of an aerosol-generating article 100. The aerosol-generating article 100 comprises a rod of aerosol-forming substrate 110 and a downstream section 115 at a location downstream of the rod of aerosol-forming substrate 110. The aerosol-generating article 100 comprises an upstream section 150 at a location upstream of the rod of aerosol-forming substrate 110. Thus, the aerosol-generating article 100 extends from an upstream or distal end 180 to a downstream or mouth end 170. In use, air is drawn through the aerosol-generating article 100 by a user from the distal end 180 to the mouth end 170.

The downstream section 115 comprises a support element 120 located immediately downstream of the rod of aerosol-forming substrate 110, the support element 120 being in longitudinal alignment with the rod 110. The upstream end of the support element 120 abuts the downstream end of the rod of aerosol-forming substrate 110. In addition, the downstream section 115 comprises an aerosol-cooling element 130 located immediately downstream of the support element 120, the aerosol-cooling element 130 being in longitudinal alignment with the rod 110 and the support element 120. The upstream end of the aerosol-cooling element 130 abuts the downstream end of the support element 120. In use, volatile substances released from the aerosol-forming substrate 110 pass along the aerosol-cooling element 130 towards the mouth end 170 of the aerosol-generating article 100. The volatile substances may cool within the aerosol-cooling element 130 to form an aerosol that is inhaled by the user.

The support element 120 comprises a first hollow tubular segment 125. The first hollow tubular segment 125 is provided in the form of a hollow cylindrical tube made of cellulose acetate. The first hollow tubular segment 125 defines an internal cavity 145 that extends all the way from an upstream end 165 of the first hollow tubular segment 125 to a downstream end 175 of the first hollow tubular segment 125.

The aerosol-cooling element 130 comprises a second hollow tubular segment 135. The second hollow tubular segment 135 is provided in the form of a hollow cylindrical tube made of cellulose acetate. The second hollow tubular segment 135 defines an internal cavity 155 that extends all the way from an upstream end 185 of the second hollow tubular segment 135 to a downstream end 195 of the second hollow tubular segment 135. In addition, a ventilation zone (not shown) is provided at a location along the second hollow tubular segment 135. A ventilation level of the aerosol-generating article 100 is about 25 percent.

The downstream section 115 further comprises a mouthpiece 140 positioned immediately downstream of the aerosol-cooling element 130. As shown in the drawing of FIG. 1, an upstream end of the mouthpiece 140 abuts the downstream end 195 of the aerosol-cooling element 130. The mouthpiece 140 is provided in the form of a cylindrical plug of low-density cellulose acetate.

The aerosol-generating article 100 further comprises an elongate susceptor 160 within the rod of aerosol-generating substrate 110. In more detail, the susceptor 160 is arranged substantially longitudinally within the aerosol-forming substrate 110, such as to be approximately parallel to the longitudinal direction of the rod 110. As shown in the drawing of FIG. 1, the susceptor 160 is positioned in a radially central position within the rod and extends effectively along the longitudinal axis of the rod 110.

The susceptor 160 extends all the way from an upstream end to a downstream end of the rod of aerosol-forming substrate 110. In effect, the susceptor 160 has substantially the same length as the rod of aerosol-forming substrate 110. The susceptor 160 is located in thermal contact with the aerosol-forming substrate 110, such that the aerosol-forming substrate 110 is heated by the susceptor 160 when the susceptor 160 is heated.

The upstream section 150 comprises an upstream element 190 located immediately upstream of the rod of aerosol-forming substrate 110, the upstream element 190 being in longitudinal alignment with the rod 110. The downstream end of the upstream element 190 abuts the upstream end of the rod of aerosol-forming substrate. This advantageously prevents the susceptor 160 from being dislodged. Further, this ensures that the consumer cannot accidentally contact the heated susceptor 160 after use. The upstream element 190 is provided in the form of a cylindrical plug of cellulose acetate circumscribed by a stiff wrapper.

The susceptor 160 comprises at least two different materials. The susceptor 160 comprises at least two layers: a first layer of a first susceptor material disposed in physical contact with a second layer of a second susceptor material. The first susceptor material and the second susceptor material may each have a Curie temperature. In this case, the Curie temperature of the second susceptor material is lower than the Curie temperature of the first susceptor material. The first material may not have a Curie temperature. The first susceptor material may be aluminum, iron or stainless steel. The second susceptor material may be nickel or a nickel alloy.

The susceptor 160 may be formed by electroplating at least one patch of the second susceptor material onto a strip of the first susceptor material. The susceptor may be formed by cladding a strip of the second susceptor material to a strip of the first susceptor material.

The aerosol-generating article 100 illustrated in FIG. 1 is designed to engage with an aerosol-generating device, such as the aerosol-generating device 200 illustrated in FIG. 2A, for producing an aerosol. The aerosol-generating device 200 comprises a housing 210 having a cavity 220 configured to receive the aerosol-generating article 100 and an inductive heating device 230 configured to heat an aerosol-generating article 100 for producing an aerosol. FIG. 2B illustrates the aerosol-generating device 200 when the aerosol-generating article 100 is inserted into the cavity 220. The aerosol-generating device 200 may optionally further comprise a puff detector located within or near the cavity 220 (not shown) for detecting puffs. The puff detector is located within or near the cavity 200 such that the puff detector is placed along the path of the airflow when a user takes a puff. The puff detector may comprise one or more temperature detectors to detect a temperature change of air flow in the cavity 220 indicative of the user taking a puff. Additionally, or alternatively, the puff detector may comprise a pressure sensor to detect a decrease in pressure of the air flow in the cavity 220 indicative of a user taking a puff. The inductive heating device 230 is illustrated as a block diagram in FIG. 3. The inductive heating device 230 comprises a DC power source 310 and a heating arrangement 320 (also referred to as power supply electronics). The heating arrangement 320 comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 160, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 110 of the aerosol-generating article 100 is located adjacent to the inductor 240 so that the susceptor 160 of the aerosol-generating article 100 is located within this alternating magnetic field. When the alternating magnetic field penetrates the susceptor 160, the alternating magnetic field causes heating of the susceptor 160. For example, eddy currents are generated in the susceptor 160 which is heated as a result. Further heating is provided by magnetic hysteresis losses within the susceptor 160. The heated susceptor 160 heats the aerosol-forming substrate 110 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 160.

FIG. 6 illustrates the relationship between the DC current I_{DC} drawn from the power source 310 over time as the temperature of the susceptor 160 (indicated by the dashed line) increases. More specifically, FIG. 6 illustrates the remotely-detectable DC current changes that occur when a susceptor material undergoes a phase transition associated with its Curie point. The DC current I_{DC} drawn from the power source 310 is measured at an input side of the DC/AC converter 340. For the purpose of this illustration, it may be assumed that the voltage V_{DC} of the power source 310 remains approximately constant.

As the susceptor 160 is inductively heated, the apparent resistance of the susceptor 160 increases. This increase in resistance is observed as a decrease in the DC current I_{DC} drawn from the power source 310, which at constant voltage decreases as the temperature of the susceptor 160 increases. The high frequency alternating magnetic field provided by the inductor 240 induces eddy currents in close proximity to the susceptor surface, an effect that is known as the skin effect. The resistance in the susceptor 160 depends in part on the electrical resistivity of the first susceptor material, the resistivity of the second susceptor material and in part on the depth of the skin layer in each material available for induced eddy currents, and the resistivity is in turn temperature dependent.

As the second susceptor material reaches its Curie temperature, it loses its magnetic properties. This causes an increase in the skin layer available for eddy currents in the second susceptor material, which causes a decrease in the apparent resistance of the susceptor 160. The result is a temporary increase in the detected DC current I_{DC}. Then, when the skin depth of the second susceptor material begins to increase, the resistance begins to fall. This is seen as the valley (the local minimum) in FIG. 6.

As heating continues, the current continues to increase until the maximum skin depth is reached, which coincides with the point where the second susceptor material has lost its spontaneous magnetic properties. This point is called the Curie temperature and is seen as the hill (the local maximum) in FIG. 6. At this point the second susceptor material has undergone a phase change from a ferro-magnetic or ferri-magnetic state to a paramagnetic state. At this point, the susceptor 160 is at a known temperature (the Curie temperature, which is an intrinsic material-specific temperature).

If the inductor 240 continues to generate an alternating magnetic field (i.e. power to the DC/AC converter 340 is not interrupted) after the Curie temperature has been reached, the eddy currents generated in the susceptor 160 will run against the resistance of the susceptor 160, whereby Joule heating in the susceptor 160 will continue, and thereby the resistance will increase again (the resistance will have a polynomial dependence of the temperature, which for most metallic susceptor materials can be approximated to a third degree polynomial dependence for our purposes) and current will start falling again as long as the inductor 240 continues to provide power to the susceptor 160.

Therefore, the second susceptor material undergoes a reversible phase transition when heated through the (known) temperature range between the valley and the hill shown in FIG. 6.

As can be seen from FIG. 6, the apparent resistance of the susceptor 160, and hence the start and end of the phase transition, can be remotely detected by monitoring the DC current I_{DC} drawn from the power source 310. Alternatively, the apparent resistance of the susceptor 160, and hence the start and end of the phase transition, can be remotely detected by monitoring a conductance value (where conductance is defined as the ratio of the DC current I_{DC} to the DC supply voltage V_{DC}) or a resistance value (where resistance is defined as the ratio of the DC supply voltage V_{DC} to the DC current I_{DC}). At least the DC current I_{DC} drawn from the power source 310 is monitored by the controller 330. Although the DC supply voltage V_{DC} is known, preferably both the DC current I_{DC} drawn from the power source 310 and the DC supply voltage V_{DC} are monitored. The DC current I_{DC}, the conductance value and the resistance value may be referred to as power source parameters.

As the susceptor 160 is heated, a first turning point (corresponding to a local minimum for current and a local maximum for resistance) corresponds to the start of the phase transition. Then, as the susceptor continues to be heated, a second turning point (corresponding to a local maximum for current and a local minimum for resistance) corresponds to the end of the phase transition.

Furthermore as can be seen from FIG. 6, the apparent resistance of the susceptor 160 (and correspondingly the current I_{DC} drawn from the power source 310) may vary with the temperature of the susceptor 160 in a strictly monotonic relationship over certain ranges of temperature of the susceptor 160, such as between the valley and the hill. The strictly monotonic relationship allows for an unambiguous determination of the temperature of the susceptor 160 from a determination of the apparent resistance (R) or apparent conductance (1/R). This is because each determined value of the apparent resistance is representative of only one single value of the temperature, so that there is no ambiguity in the relationship. The monotonic relationship of the temperature of the susceptor 160 and the apparent resistance in the temperature range in which the second susceptor material undergoes the reversible phase transition allows for the determination and control of the temperature of the susceptor 160 and thus for the determination and control of the temperature of the aerosol-forming substrate 110.

The controller 330 regulates the supply of power provided to the heating arrangement 320 based on a power supply parameter. The heating arrangement 320 may comprise a current sensor (not shown) to measure the DC current I_{DC}. The heating arrangement may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power PAC to the inductor 240.

The controller 330 may control the temperature of the susceptor 160 by maintaining the measured power supply parameter value at a target value corresponding to a target operating temperature of the susceptor 160. The controller 330 may use any suitable control loop to maintain the measured power supply parameter at the target value, for example by using a proportional-integral-derivative control loop.

In order to take advantage of the strictly monotonic relationship between the apparent resistance (or apparent conductance) of the susceptor 160 and the temperature of the susceptor 160, during user operation for producing an aerosol, the power supply parameter measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill in the current plot in FIG. 6). The first calibration temperature is a temperature greater than or equal to the temperature of the susceptor at which the skin depth of the second susceptor material begins to increase, leading to a temporary lowering of the resistance (the valley in the current plot in FIG. 6). Thus, the first calibration temperature is a temperature greater than or equal to the temperature at maximum permeability of the second susceptor material. The first calibration temperature is at least 50 degrees Celsius lower than the second calibration temperature. At least the second calibration value may be determined by calibration of the susceptor 160, as will be described in more detail below. The first calibration value and the second calibration value may be stored as calibration values in a memory of the controller 330.

Further, the controller 330 may maintain the temperature of the susceptor 160 below a predetermined threshold temperature by maintaining the measured conductance or current value below a predetermined threshold conductance value or by maintaining the measured resistance value above a predetermined threshold resistance value. The predetermined threshold temperature is chosen to prevent overheating of the aerosol-forming substrate. The predetermined threshold temperature may be the same as the second calibration temperature. If the measured power supply parameter indicates that the temperature of the susceptor is above the predetermined threshold temperature, the controller 330 is programmed to enter a safety mode. In the safety mode, the controller 330 is configured to perform one or more actions such as generating an alarm that (visually and additionally or alternatively audibly) provides an overheating warning to the user, switching off the aerosol-generating device and preventing further use if the aerosol-generating device for a predefined period of time.

Since the power supply parameter will have a polynomial dependence on the temperature, the power supply parameter will behave in a nonlinear manner as a function of temperature.

However, the first and the second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the power supply parameter is regulated according to the first calibration value and the second calibration value, through linear equations.

For example, if the first and the second calibration values are conductance values, the target conductance value corresponding to the target operating temperature may be given by:

$${G}_{T a r g e t} = {G}_{L o w e r} + ( x \times Δ G )$$

where ΔG is the difference between the first conductance value and the second conductance value and x is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 160, and simultaneously the DC current I_{DC} and optionally the DC supply voltage V_{DC} may be measured, preferably every millisecond for a period of 100 milliseconds.

For example, if the conductance or current is monitored by the controller 330 for adjusting the susceptor temperature, when the conductance or current reaches or exceeds a value corresponding to the target operating temperature for adjusting the susceptor temperature, the duty cycle of the switching transistor 410 is reduced. If the resistance is monitored by the controller 330 for adjusting the susceptor temperature, when the resistance reaches or goes below a value corresponding to the target operating temperature, the duty cycle of the switching transistor 410 is reduced. For example, the duty cycle of the switching transistor 410 may be reduced to about 10%. In other words, the switching transistor 410 may be switched to a mode in which it generates pulses only every 10 milliseconds for a duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 160 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 160. The probing pulses are isolated power pulses having an intensity such not to heat the susceptor 160 but rather to obtain a feedback on the power supply parameter and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to perform a calibration process in order to obtain the calibration values at which the power supply parameter is measured at known temperatures of the susceptor 160. The known temperatures of the susceptor may be the first calibration temperature corresponding to the first calibration value and the second calibration temperature corresponding to the second calibration value. The calibration process is performed each time the user operates the aerosol-generating device 200. For example, the controller 330 may be configured to enter a calibration mode for performing the calibration process when the user switches on the aerosol-generating device. The controller 330 may be programmed to enter the calibration mode each time the user inserts an aerosol-generating article 100 into an aerosol-generating device 200. Thus, the calibration process is performed during a first heating phase of the aerosol-generating device, before user operation of the aerosol-generating device 200 for generating an aerosol.

During the calibration process, the controller 330 controls the DC/AC converter 340 to continuously or continually supply power to the inductor 240 in order to heat the susceptor 160. The controller 330 monitors the power supply parameter by measuring the current I_{DC} drawn by the power supply and, optionally the power supply voltage V_{DC}. As discussed above in relation to FIG. 6, as the susceptor 160 is heated, the measured current decreases until a first turning point is reached and the current begins to increase. This first turning point corresponds to a local minimum conductance or current value (a local maximum resistance value). The controller 330 may record the power supply parameter at the first turning point as the first calibration value.

The conductance or resistance values may be determined based on the measured current I_{DC} and the measured voltage V_{DC}. Alternatively, it may be assumed that the power supply voltage V_{DC}, which is a known property of the power source 310, is approximately constant. The temperature of the susceptor 160 at the first calibration value is referred to as the first calibration temperature. Preferably, the first calibration temperature is between 150 degrees Celsius and 350 degrees Celsius. More preferably, when the aerosol-forming substrate 110 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the controller 330 continues to monitor the power supply parameter until a second turning point is reached. The second turning point corresponds to a maximum current (corresponding to the Curie temperature of the second susceptor material) before the measured current begins to decrease. This turning point corresponds to a local maximum conductance or current value (a local minimum resistance value). The controller 330 records the power supply parameter value at the second turning point as the second calibration value. The temperature of the susceptor 160 at the second calibration value is referred to as the second calibration temperature. Preferably, the second calibration temperature is between 200 degrees Celsius and 400 degrees Celsius. When the maximum is detected, the controller 330 controls the DC/AC converter 340 to interrupt provision of power to the inductor 240, resulting in a decrease in susceptor 160 temperature and a corresponding decrease in measured current.

Due to the shape of the graph, this process of continuously heating the susceptor 160 to obtain the first calibration value and the second calibration value may be repeated at least once during the calibration mode. After interrupting provision of power to the inductor 240, the controller 330 continues to monitor the power supply parameter until a third turning point is observed. The third turning point corresponds to a second minimum conductance or current value (a second maximum resistance value). When the third turning point is detected, the controller 330 controls the DC/AC converter 340 to continuously provide power to the inductor 240 until a fourth turning point in the monitored power supply parameter is observed. The fourth turning point corresponds to a second maximum conductance or current value (a second minimum resistance value). The controller 330 stores the power supply parameter value that is measured at the third turning point as the first calibration value and the power supply parameter value measured the fourth turning point as the second calibration value. The repetition of the measurement of the turning points corresponding to minimum and maximum measured current significantly improves the subsequent temperature regulation during user operation of the device for producing an aerosol. Preferably, controller 330 regulates the power based on the power supply parameter values obtained from the second maximum and the second minimum, this being more reliable because the heat will have had more time to distribute within the aerosol-forming substrate 110 and the susceptor 160.

The controller 330 is configured to detect the turning points by measuring a sequence of power source parameter values. With reference to FIG. 6, the sequence of measured power source parameter values will form a curve, with each value being greater than or less than the previous value. The controller 330 is configured to measure the calibration value at the point where the curve begins to flatten. In other words, the controller 330 records the calibration values when the difference between consecutive power supply parameter values is below a predetermined threshold value.

Further, during the first heating phase, in order to further improve the reliability of the calibration process, the controller 310 may be optionally programmed to perform a pre-heating process before the calibration process. For example, if the aerosol-forming substrate 110 is particularly dry or in similar conditions, the calibration may be performed before heat has spread within the aerosol-forming substrate 110, reducing the reliability of the calibration values. If the aerosol-forming substrate 110 were humid, the susceptor 160 takes more time to reach the valley temperature (due to water content in the substrate 110).

To perform the pre-heating process, the controller 330 is configured to continuously provide power to the inductor 240. As described above with respect to FIG. 6, the measured current starts decreasing with increasing susceptor 160 temperature until a turning point corresponding to minimum measured current is reached. At this stage, the controller 330 is configured to wait for a predetermined period of time to allow the susceptor 160 to cool before continuing heating. The controller 330 therefore controls the DC/AC converter 340 to interrupt provision of power to the inductor 240. After the predetermined period of time, the controller 330 controls the DC/AC converter 340 to provide power until the turning point corresponding to the minimum measured current is reached again. At this point, the controller controls the DC/AC converter 340 to interrupt provision of power to the inductor 240 again. The controller 330 again waits for the same predetermined period of time to allow the susceptor 160 to cool before continuing heating. This heating and cooling of the susceptor 160 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 110 is dry, the first current minimum of the pre-heating process is reached within the pre-determined period of time and the interruption of power will be repeated until the end of the predetermined time period. If the aerosol-forming substrate 110 is humid, the first current minimum of the pre-heating process will be reached towards the end of the pre-determined time period. Therefore, performing the pre-heating process for a predetermined duration ensures that, whatever the physical condition of the substrate 110, the time is sufficient for the substrate 110 to reach the minimum operating temperature, in order to be ready to feed continuous power and reach the first maximum. This allows a calibration as early as possible, but still without risking that the substrate 110 would not have reached the valley beforehand.

Further, the aerosol-generating article 100 may be configured such that the current minimum is always reached within the predetermined duration of the pre-heating process. If the current minimum is not reached within the pre-determined duration of the pre-heating process, this may indicate that the aerosol-generating article 100 comprising the aerosol-forming substrate 110 is not suitable for use with the aerosol-generating device 200. For example, the aerosol-generating article 100 may comprise a different or lower-quality aerosol-forming substrate 110 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to cease operation of the aerosol-generating device 200.

As mentioned above, as the first stage of the calibration process, the pre-heating process may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200.

During user operation of the aerosol-generating device 200 for generating an aerosol (referred to as the second heating phase), the apparent conductance (apparent resistance) values at the hill and valley shown in FIG. 6 drift over time. This is because, as shown in FIG. 5, the apparent resistance of the susceptor is the sum of the ohmic resistance R_{coil} of the inductor L2 and the ohmic resistance R_{load} of the susceptor 160. Therefore any change to the temperature of the inductor L2 during operation of the device 200 will affect the apparent resistance. Therefore, the calibration values measured during the calibration process in the first heating phase will drift during operation of the aerosol-generating device 200.

During normal operation when the aerosol-generating device 200 is generating an aerosol, the controller 330 will be operating in a heating mode for heating the aerosol-forming substrate. The controller 330 may be programmed to enter, from the heating mode, a recalibration mode for performing further iterations of at least part of the calibration process at predefined intervals during user operation of the aerosol-generating device 200 for generating an aerosol. The predefined intervals may be predefined time intervals or a predetermined number of puffs. Additionally, or alternatively, the controller 330 may be programmed to enter the recalibration mode for repeating at least part of the calibration process in response to detection of the completion of a puff. The calibration process may take between 200 milliseconds and 2 seconds to perform.

Performing the further iterations of at least part of the calibration process may comprise re-measuring both the calibration value at both turning points (illustrated as the hill and the valley in FIG. 6) or re-measuring only the calibration value at one of the turning points, for example at the local maximum of current or conductance (the local minimum of resistance)

To perform a further iteration of the calibration process (in other words, to perform a recalibration), the controller 330 monitors the power source parameter associated with the susceptor 160 by measuring the current I_{DC} drawn by the power supply and, optionally the power supply voltage V_{DC}. Because the minimum operating temperature of the aerosol-generating device is greater than the first calibration temperature, as the susceptor 160 is heated during the further iterations of the calibration process, the measured current I_{DC} increases until a turning point is reached and the current I_{DC} begins to decrease. This turning point corresponds to the end point of the reversible phase transition of the susceptor 160, observed as a local maximum conductance or current value (a local minimum resistance value). The controller 330 records the power source parameter value at the turning point as the re-measured second calibration value.

Once the turning point has been reached, the controller 330 controls the DC/AC converter 340 to reduce the power provided to the inductor 240 in order to enable the susceptor 160 to cool. For example, the controller 330 may reduce the duty cycle of the DC/AC converter 340 to 10%. The controller 330 may reduce the power provided to the inductor 240 until the susceptor 160 reaches the respective target operating temperature, at which point the controller 300 resumes normal operation in the heating mode.

Alternatively, the controller 330 may continue to reduce the power provided to the inductor 240 until another turning point is observed. This another turning point corresponds to the end point of the reversible phase transition of the susceptor, observed as a local minimum conductance or current value (a local maximum resistance value). The controller 330 records the power source parameter value at the another turning point as the re-measured first calibration value. As described above with respect to the calibration process, the process of measuring the first calibration value and the second calibration value may be repeated at least once during each further iteration of the calibration process.

FIG. 7 is a graph of conductance against time showing a heating profile of the susceptor 160. The graph illustrates two consecutive phases of heating: a first heating phase 710 comprising the pre-heating process 710A and the calibration process 710B described above, and a second heating phase 720 corresponding to user operation of the aerosol-generating device 200 to produce an aerosol. As described above, during the first heating phase 710, the controller 330 operates in a calibration mode. Once calibration is complete, the controller enters a heating mode and may periodically switch to a re-calibration mode during the second heating phase 720. It is to be understood that FIG. 7 is not shown to scale. Specifically, the first heating phase 710 has a shorter duration that the second heating phase 720. For example, the first heating phase 710 may have a duration of between 5 seconds and 30 seconds, preferably between 10 and 20 seconds. The second heating phase 720 may have a duration of between 140 and 340 seconds.

Further, although FIG. 7 is illustrated as a graph of conductance against time, it is to be understood that the controller 330 may be configured to control the heating of the susceptor 160 during the first heating phase 710 and the second heating phase 720 based on measured resistance or current as described above. Indeed, although the techniques to control of the heating of the susceptor during the first heating phase 710 and the second heating phase 720 have been described above based on a determined conductance value or a determined resistance value associated with the susceptor, it is to be understood that the techniques described above could be performed based on a value of current measured at the input of the DC/AC converter 340.

As can be seen from FIG. 7, the second heating phase 720 comprises a plurality of conductance steps, corresponding to a plurality of temperature steps from a first operating temperature of the susceptor 160 to a second operating temperature of the susceptor 160. The first operating temperature of the susceptor is a temperature at which the aerosol-forming substrate 110 forms an aerosol so that an aerosol is formed during each temperature step. Preferably, the first operating temperature of the susceptor is a minimum temperature at which the aerosol-forming substrate will form an aerosol in a sufficient volume and quantity for a satisfactory experience when inhaled a user. The second operating temperature of the susceptor is the temperature at maximum temperature at which it is desirable for the aerosol-forming substrate to be heated for the user to inhale the aerosol.

The first operating temperature of the susceptor 160 is greater than or equal to the first calibration temperature of the susceptor 160, corresponding to the first calibration value (the valley of the current plot shown in FIG. 6). The first operating temperature may be between 150 degrees Celsius and 330 degrees Celsius. The second operating temperature of the susceptor 160 is less than or equal to the second calibration temperature of the susceptor 160, corresponding to the second calibration value at the Curie temperature of the second susceptor material (the hill of the current plot shown in FIG. 6). The second operating temperature may be between 200 degrees Celsius and 400 degrees Celsius. The difference between the first operating temperature and the second operating temperature is at least 50 degree Celsius.

It is to be understood that the number of temperature steps illustrated in FIG. 7 is exemplary and that second heating phase 720 comprises at least three consecutive temperature steps, preferably between two and fourteen temperature steps, most preferably between three and eight temperature steps. Each temperature step may have a predetermined duration. Preferably the duration of the first temperature step is longer than the duration of subsequent temperature steps. The duration of each temperature step is preferably longer than 10 seconds, preferably between 30 seconds and 200 seconds, more preferably between 40 seconds and 160 seconds. The duration of each temperature step may correspond to a predetermined number of user puffs. Preferably, the first temperature step corresponds to four user puffs and each subsequent temperature step corresponds to one user puff.

For the duration of each temperature step, the temperature of the susceptor 160 is maintained at a target operating temperature corresponding to the respective temperature step. Thus, for the duration of each temperature step, the controller 330 controls the provision of power to the heating arrangement 320 such that the measured power source parameter is maintained at a target value corresponding to the target operating temperature of the respective temperature step, where the target value is determined with reference to the first calibration value and the second calibration value as described above.

As an example, the second heating phase 720 may comprise five temperature steps: a first temperature step 720a having a duration of 160 seconds and a target conductance value of G_{Target}=G_{Lower}+(0.09×ΔG), a second temperature step 720b having a duration of 40 seconds and a target conductance value of G_{Target}=G_{Lower}+(0.25×ΔG), a third temperature step 720c having a duration of 40 seconds and a target conductance value of G_{Target}=G_{Lower}+(0.4×ΔG), a fourth temperature step 720d having a duration of 40 seconds and a target conductance value of G_{Target}=G_{Lower}+(0.56×ΔG) and a fifth temperature step 720e having a duration of 85 seconds and a target conductance value of G_{Target}=G_{Lower}+(0.75×ΔG). These temperature steps may correspond to temperatures of 330 degrees Celsius, 340 degrees Celsius, 345 degrees Celsius, 355 degrees Celsius and 380 degrees Celsius.

Thus, control of the operating temperature of the susceptor 160 for generating an aerosol depends on the first calibration value (corresponding to the first calibration temperature) and the second calibration value (corresponding to the second calibration temperature) measured during the calibration process. However, the drift in the apparent conductance of the susceptor over the duration of the second heating phase 720, means that, for the same susceptor temperature, the value of the apparent conductance decreases over the duration of the second heating phase 720. Therefore, in order to be able to accurately control the susceptor temperature as well as to prevent overheating of the aerosol-forming substrate 110, the controller 330 is programmed to periodically enter the re-calibration mode for repeating the at least part of the calibration process during the second heating phase 720. For example, at least part of the calibration process is repeated every 15 seconds to 2 minutes. Preferably, at least part of the calibration process is repeated every 30 seconds. This is illustrated in FIG. 8, which shows the second heating phase 720 in more detail, including recalibration during each of the temperature steps. Again, FIG. 8 is for illustration purposes and is not drawn to scale.

As described above, at least the second calibration value is re-measured during the further iterations of the calibration process, as shown in FIG. 8. Optionally, the first calibration value is re-measured during the further iterations of the calibration process. Target power source parameter values corresponding to each temperature step may be stored in the memory of the controller 330 and updated after each iteration of the calibration process. The controller 330 may adjust the target power source parameter value for each respective temperature step based on at least one of the re-measured calibration values, in other words based on at least the re-measured second calibration value. Additionally, or alternatively, the controller 330 may adjust the target power source parameter values for each respective temperature step based on the re-measured first calibration value. Additionally, or alternatively, the controller 330 may adjust the target power source parameter value for each respective temperature step based on a combination of the one or more calibration values measured during the first heating phase 710 and one or more calibration values measured during at least one further iteration of the calibration process during the second heating phase 720.

Therefore, in the example above, for the first temperature step 720a, the target conductance will be based, at least initially at the start of the heating mode, on the calibration values G_{Lower} and ΔG obtained during the calibration process 710B of the first heating phase 710. Assuming that the controller 330 is programmed to repeat the calibration process every 30 seconds, the calibration process will be repeated five times during the first temperature step, after 30 seconds, 60 seconds, 90 seconds, 120 seconds and 150 seconds. The calibration process will be repeated once during the second temperature step 720b after 180 seconds (20 seconds after the beginning of the second temperature step). The calibration process will be repeated once during the third temperature step 720c after 210 seconds (10 seconds after the beginning of the third temperature step) and at the end of the third temperature step 720c at 240 seconds. The calibration process will be repeated once during the fourth temperature step 720d after 280 seconds (30 seconds after the beginning of the third temperature step). The calibration process will be repeated twice during the fifth temperature step 720e after 320 seconds (20 seconds after the beginning of the fifth temperature step) and after 350 seconds (50 seconds after the beginning of the fifth temperature step). After each further iteration of the calibration process, the controller 330 will adjust G_{Target} based at least in part on at least one of the calibration values resulting from the latest further iteration of the calibration process. For example, the target conductance after each recalibration is adjusted based at least in part on the re-measured calibration values G_{Lower_i} and ΔGᵢ obtained during the respective recalibration process or based on the calibration value G_{Lower} and the re-measured value ΔGᵢ obtained during the respective recalibration process, where i=start time of the second heating phase 720 +30 seconds.

During the second heating phase 720, the user will be drawing the aerosol generated by the aerosol-generating device 200 into their body. In other words, the user will be puffing on the mouthpiece 140 of the aerosol-generating article 100 that is partly received in the aerosol-generating device 200. When the user puffs, cold air is drawn into the aerosol-generating device 200 and through the aerosol-generating article 100, thereby cooling the susceptor 160. Therefore, if recalibration is performed during a puff, the temporary cooling of the susceptor 160 has the effect of temporarily decreasing the difference between the calibration values (for example, decreasing the value of ΔG). In other words, referring again to FIG. 6, there is a temporary decrease in the value of current at the hill and a temporary increase in the value of current at the valley for the duration of the puff. Thus, calibration values measured during a user puff will not be accurate. In particular, if the calibration values obtained during a puff were used to control the temperature of the susceptor 160, there would be a risk of overheating the susceptor 160 with the consequent release of unwanted aerosol constituents. The controller 330 is therefore programmed such that recalibration does not overlap with a puff. This is indicated by the arrows in FIG. 8.

For example, if the controller 330 receives a signal from the puff detector indicating that the puff detector has detected a puff at a predetermined time interval before the controller 330 is scheduled to enter in to the recalibration mode to re-measure the calibration values, the controller 330 postpones entering the recalibration mode until after a signal is received from the puff detector that the puff is completed. Then, in response to receiving a signal from the puff detector that the puff is completed, the controller 330 enters the recalibration mode performs the calibration process to re-measure the calibration values.

If the controller receives a signal from the puff detector indicating that the puff detector has detected a puff during the recalibration mode, the controller 330 stops the calibration process and exits the calibration mode to return to the heating mode. Then, in response to receiving a signal from the puff detector that the puff is completed, the controller 330 enters the calibration mode to perform the calibration process.

It is to be understood that the puff detector is optional and that the controller 330 may be programmed to determine the beginning and end of a puff based on a change of the measured conductance, resistance or current.

FIG. 9 is a flow diagram of a method 900 for controlling aerosol-production in an aerosol-generating device 200. As described above, the controller 330 may be programmed to perform the method 900.

The method begins at step 910, where the controller 330 detects user operation of the aerosol-generating device 200 for producing an aerosol. Detecting user operation of the aerosol-generating device 200 may comprise detecting a user input, for example user activation of the aerosol-generating device 200. Additionally or alternatively, detecting user operation of the aerosol-generating device 200 may comprise detecting that an aerosol-generating article 100 has been inserted into the aerosol-generating device 200.

In response to detecting the user operation at step 910, the controller 330 enters a calibration mode. During the calibration mode, the controller 330 may be configured to perform, at step 920, the optional pre-heating process described above. At the end of the predetermined duration of the pre-heating process, the controller 330 is configured to perform the calibration process (step 930) as described above. Alternatively, during the calibration mode, the controller 330 may be configured to proceed to step 930 without performing the pre-heating process. Following completion of the calibration process, the controller 330 enters the heating mode of the second heating phase in which the aerosol is produced at step 940. Periodically during the second heating phase, the controller 330 is configured to enter a re-calibration mode in which the controller 330 repeats the calibration process.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method for controlling aerosol production in an aerosol-generating device, the aerosol-generating device comprising an inductive heating arrangement and a power source configured to provide power to the inductive heating arrangement, the method comprising:
performing, during a first heating phase during user operation of the aerosol-generating device for producing an aerosol, a first iteration of a calibration process for measuring one or more calibration values associated with a susceptor inductively coupled to the inductive heating arrangement, wherein the susceptor is configured to heat an aerosol-forming substrate; and
during a second heating phase during user operation of the aerosol-generating device for producing the aerosol:
controlling power provided to the inductive heating arrangement such that a temperature of the susceptor is adjusted based on the one or more calibration values,
re-measuring at least one of the one or more calibration values by performing one or more further iterations of the calibration process for adjusting the one or more calibration values, wherein the temperature of the susceptor is adjusted based at least in part on the at least one of the one or more calibration values resulting from a latest iteration of the calibration process prior to adjusting the temperature of the susceptor, and
in response to detecting a puff during user operation of the device, preventing re-measuring of the at least one of the one or more calibration values.

17. The method according to claim 16,
wherein the one or more further iterations of the calibration process are performed at predetermined time intervals, and
wherein each of the predetermined time intervals is between 20 seconds and 50 seconds.

18. The method according to claim 16, wherein the preventing the re-measuring of the at least one of the one or more calibration values in response to detecting the puff comprises, in response to detecting the puff at a predetermined duration of time before performing a respective iteration of calibration process, postponing the respective iteration of the calibration process for a duration of the detected puff.

19. The method according to claim 16, wherein the preventing the re-measuring of the at least one of the one or more calibration values in response to detecting a puff comprises, in response to detecting the puff during a respective iteration of the calibration process, stopping the respective iteration of the calibration process.

20. The method according to claim 16, further comprising, in response to the detection that the puff is completed, performing the respective iteration of the calibration process.

21. The method according to claim 16, further comprising detecting the puff by detecting a change of current, resistance, or conductance associated with the susceptor.

22. The method according to claim 16, wherein the performing the calibration process comprises:
controlling the power provided to the inductive heating arrangement to cause heating and cooling of the susceptor through a predetermined temperature range, and
monitoring a power source parameter to identify a start point and an end point of a reversible phase transition of the susceptor,
wherein the one or more calibration values comprise at least a first power source parameter value corresponding to the start point of the reversible phase transition of the susceptor and a second power source parameter value corresponding to the end point of the reversible phase transition of the susceptor.

23. An aerosol-generating device, comprising:
a power source configured to provide a DC supply voltage and a DC current; and
power supply electronics connected to the power source, the power supply electronics comprising:
a DC/AC converter,
an inductor connected to the DC/AC converter for the generation of an alternating magnetic field, when energized by an alternating current from the DC/AC converter, the inductor being couplable to a susceptor, wherein the susceptor is configured to heat an aerosol-forming substrate, and
a controller configured to:
perform, during a first heating phase during user operation of the aerosol-generating device for producing an aerosol, a first iteration of a calibration process for measuring one or more calibration values associated with the susceptor, and
during a second heating phase during user operation of the aerosol-generating device for producing an aerosol:
control power provided to the power supply electronics such that the temperature of the susceptor is adjusted based on the one or more calibration values, and
re-measure at least one of the one or more calibration values by performing one or more further iterations of the calibration process for adjusting the one or more calibration values, wherein the temperature of the susceptor is adjusted based at least in part on the at least one of the one or more calibration values resulting from a latest iteration of the calibration process prior to adjusting the temperature of the susceptor,
wherein the controller is further configured to, in response to detecting a puff during user operation of the device, prevent re-measuring the at least one of the one or more calibration values.

24. The aerosol-generating device according to claim 23, wherein the preventing of the re-measuring the at least one of the one or more calibration values in response to detecting a puff comprises:
in response to detecting a puff at a predetermined duration of time before performing a respective iteration of calibration process, postpone performing a respective iteration of the calibration process for the duration of the puff, and
in response to detecting a puff during a respective iteration of the calibration process, stop the respective iteration of the calibration process.

25. The aerosol-generating device according to claim 23,
wherein performing the calibration process comprises:
controlling the power provided to the inductive heating arrangement to cause heating and cooling of the susceptor through a predetermined temperature range, and
monitoring a power source parameter to identify a start point and an end point of a reversible phase transition of the susceptor, wherein the power source parameter is one of a current, a conductance, or a resistance,
wherein the one or more calibration values comprise at least a first power source parameter value corresponding to the start point of the reversible phase transition of the susceptor and a second power source parameter value corresponding to the end point of the reversible phase transition of the susceptor,
wherein identifying the start point of the reversible phase transition of the susceptor comprises measuring a first sequence of power source parameter values with decreasing temperature of the susceptor, and
wherein identifying the end point of the reversible phase transition of the susceptor comprises measuring a second sequence of power source parameter values with increasing temperature of the susceptor.

26. The aerosol-generating device according to claim 25, wherein the re-measuring of the at least one of the one or more calibration values by performing one or more further iterations of the calibration process for adjusting the one or more calibration values comprises re-measuring at least the second power source parameter value.

27. The aerosol-generating device according to claim 25, wherein the performing the one or more further iterations of the calibration process comprises:
controlling the power provided to the inductive heating arrangement to cause an increase of the temperature of the susceptor,
monitoring the power source parameter to identify the end point of the reversible phase transition of the susceptor, and
interrupting provision of power to the inductive heating arrangement when the end point is detected, wherein the power source parameter value at the end point is the second power source parameter value.

28. The aerosol-generating device according to claim 25, wherein the controlling the power provided to the inductive heating arrangement comprises adjusting, according to a heating profile, the power source parameter with reference to at least one of the first power source parameter value and the second power source parameter value.

29. The aerosol-generating device according to claim 24, further comprising:
a cavity configured to receive the aerosol-generating substrate; and
a temperature sensor located within the cavity and being configured to measure a temperature of air flow in the cavity,
wherein the controller is further configured to detect the puff based on a change of the temperature of the air flow in the cavity.

30. An aerosol-generating system, comprising:
the aerosol-generating device according to claim 23; and
an aerosol-generating article comprising the aerosol-forming substrate and the susceptor.
